(19) United States
(12) Patent Application Publication
(10) Pub. No.: US 2008/0132108 A1
(43) Pub. Date: Jun. 5, 2008

(54) Base for a reflector lamp arrangement

(75) Inventor: Wolfgang Seitz, Eichstatt (DE)

Correspondence Address: OSRAM SYLVANIA INC, 100 ENDICOTT STREET, DANVERS, MA, 01923, US

(73) Assignee: PATENT-TREUHAND-GESELLSCHAFT FUR ELEKTRISCHE GLUHLAMPEN MBH, MUNCHEN (DE)

(21) Appl. No.: 11/984,469

(22) Filed: Nov. 19, 2007

(30) Foreign Application Priority Data
Nov. 17, 2006 (DE) 10 2006 054 357.2

(51) Int. Cl. H01R 11/20

(52) U.S. Cl. 439/419

(57) ABSTRACT

A base for a reflector lamp arrangement has a cutout, into which a section of a built-in lamp of the reflector lamp arrangement can be inserted. The insertion can take place in such a way that the contacts of the built-in lamp can be connected to the contacts of the base in the cutout, and the built-in lamp is held via at least one wall section of the cutout. In addition, a base with a built-in lamp for a reflector lamp arrangement is provided. In this case, the base is cast with the built-in lamp by a composition which has low viscosity in the unhardened state, preferably by means of cement.

### TECHNICAL FIELD

The invention relates to a base for a reflector lamp arrangement and a base with a built-in lamp for such a reflector lamp arrangement.

### PRIOR ART

PAR lamps (parabolic aluminized reflector lamps) are used as system voltage reflector lamps in the higher-wattage power range. The fields of use range from stage lighting, through exhibition lighting, film and television production, country road lighting, overhead projection to professional photography, video production and advertisement projection. The advantage of such PAR lamps consists in the compact design with a high power yield and a cost-effective production.

PAR lamps are manufactured by OSRAM, for example in the form of PAR64 halogen lamps or in the form of Alupar56 lamps. The design of the Alupar56 lamps is described by way of example in the laid-open specification EP 1672276 A2 and shown in FIG. 1.

FIG. 1 shows a partial section through a built-in lamp 202, which is fastened to a base 208 via contact lugs 204, 206. Contact springs 212, 214 protrude from the basic body 210 of the base 208 opposite to the side on which the built-in lamp 202 is provided. The contact springs 212, 214 are electrically connected to the contact lugs 204, 206 and are electrically connected to contact pins 220, 222 of the built-in lamp 202 via fuses 216, 218. The built-in lamp 202 is a halogen burner, whose pinch seal is held between the contact lugs 204, 206 and is positioned on an upper face 224 of the basic body 210. Thus, the contact pins 220, 222 run into the basic body 210, but contact is made between the fuses 216, 218 and the contact lugs 204, 206 outside of the basic body 210. The upper face 224 of the basic body 210 delimits a cylinder section 226 of the basic body, onto which a reflector (not illustrated) can be positioned. The PAR lamp Alupar56 by OSRAM has a rated power of 300 W. Up to such a rated power, the reflector body may consist of aluminum and may have a reflecting surface or coating, and ambient air can be present within the reflector body.

If a higher rated power of the system voltage reflector lamp is required, the oxidation of the pin and the foil in the built-in lamps in particular above a power of 500 W needs to be taken into consideration.

By way of remedy, the reflector body is provided as a glass reflector with an inert gas filling. As a result, there is a complex production process for system voltage reflector lamps in the higher-wattage range up to, for example, 1000 W. Since the abovementioned problem associated with oxidation has effects on the life of the built-in lamp, until now it has not been possible to dispense with an inert gas filling in higher-wattage system voltage reflector lamps.

### DESCRIPTION OF THE INVENTION

The invention is based on the object of providing a base for a reflector lamp arrangement with which a simple design of the reflector lamp arrangement for built-in lamps above approximately 300 W is made possible. In addition, a base with a built-in lamp for such a reflector lamp arrangement will be provided.

This object is achieved according to the invention by the features of claims 1 and 3.

A reflector lamp arrangement having a cutout is provided, into which cutout a section of a built-in lamp of the reflector lamp arrangement can be inserted in such a way that the contacts of the built-in lamp are connected to the contacts of the base in the cutout and the built-in lamp is held via at least one wall section of the cutout. As a result, it is possible to dispense with contact springs from the prior art which are complex in production and the built-in lamp can be held with a high degree of stability using contact springs.

It is preferred that the reflector lamp arrangement is a system voltage reflector lamp arrangement, preferably a PAR lamp arrangement. In this way, an excellent mechanical connection between the built-in lamp and the base can be combined with a compact design and cost-effective production of the lamp arrangement.

In addition, a base with a built-in lamp for the reflector lamp arrangement is provided, the base having the abovedescribed properties. Thus, a mechanically robust component unit comprising a base and a built-in lamp can be provided for the reflector lamp arrangement. It is preferred if the built-in lamp is a halogen lamp, so that brilliant light with a high luminous intensity can be converted with precise predetermination of the spectral colors.

It is preferred if the built-in lamp can be fixed in the region of the pinch seal of the built-in lamp via the at least one wall section of the cutout, with the result that the built-in lamp can be held in mechanically stable fashion by the base.

It is preferred that the reflector lamp arrangement has an electrical power of at least 300 W and preferably at most 1000 W. Owing to the fixing of the built-in lamp in the cutout, the risk of oxidation can be reduced by the introduction of sealing compounds, and therefore the possible electrical power can be increased without a reduction in the life.

In a preferred embodiment, the contacts of the built-in lamp are pins, and the contacts of the base have at least one contact lug, as a result of which, in contrast to the prior art, a direct connection between the contacts in the base and the pins of the built-in lamp is possible, which is advantageous in mechanical and electrical terms.

It is further preferred if at least one contact lug of the base is welded to a pin of the built-in lamp, since, as a result, a mechanically robust connection can be maintained.

It is further preferred if the built-in lamp is encapsulated with the base by means of a composition which has low viscosity in the unhardened state, preferably with cement, as a result of which sufficient protection against oxidation can also be achieved in the higher-wattage range.

Particularly advantageous embodiments of the invention are described in the dependent claims.

### BRIEF DESCRIPTION OF THE DRAWINGS

The invention will be explained in more detail below with reference to preferred exemplary embodiments. In the drawings:

FIG. 1 shows a base and a partial section through a built-in lamp for a reflector lamp arrangement in accordance with the prior art,

FIG. 2 shows a reflector lamp arrangement corresponding to the first exemplary embodiment of the invention,

FIG. 3 shows a base and a built-in lamp for a reflector lamp arrangement corresponding to the first exemplary embodiment of the invention,

FIG. 4 shows a perspective view of a base for a first development of the first exemplary embodiment of the present invention, and

FIG. 5 shows a base for a reflector lamp arrangement corresponding to the second exemplary embodiment of the invention.

### PREFERRED EMBODIMENT OF THE INVENTION

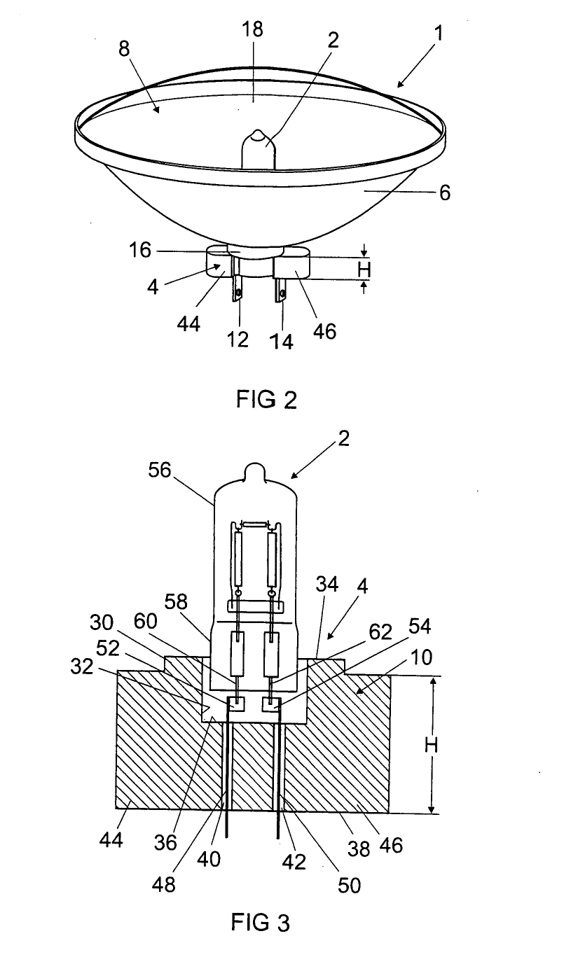

FIG. 2 shows a reflector lamp arrangement 1 having a built-in lamp 2, which is inserted into a base 4 and is surrounded by a reflector body 6. The reflector 6 is preferably formed from aluminum and has a reflecting coating 8 on its inner side pointing towards the built-in lamp 2, which coating is applied, for example, by means of high-gloss anodization from high purity aluminum.

Owing to the fact that the reflector is produced from aluminum, a reduced weight and a lower complexity in terms of production are achieved. As an alternative to this, the reflector body 6 can be manufactured from any desired material, for example from glass, and can be provided with a reflecting coating or reflecting surface. The reflector body 6 has a reflector neck 16 for fastening the reflector body on the basic body 10 of the base 4 for example by means of crimping. Opposite the reflector neck, a diffuser 18 is provided on the reflector body 6 on the light exit side, which diffuser, depending on the application case and the desired solid angle, it can be designed to be obtuse-angled for areal irradiation, acute-angled for point irradiation, smooth or with faceting.

The base 4 has a basic body 10, from which contact springs 12, 14 protrude for making electrical contact with the reflector lamp arrangement 1. The electrical contacts of the built-in lamp are electrically connected to the contact springs 12, 14.

The base 4 of the present invention differs from the base in accordance with the prior art corresponding to FIG. 2 by an enlarged height dimension H. The design of the base 4 corresponding to the first exemplary embodiment is described with reference to FIGS. 2 and 3.

The basic body 10 of the base 4 has a cylindrical holding region 30, via which the reflector neck 16 of the reflector body 6 can be connected in an interlocking manner to the base 4. A cutout 32, preferably with a square cross section, is introduced into the cylindrical holding region 30 from the upper face 34 of the cylindrical holding region 30. Contact spring cutouts 40, 42 extend from the bottom face 36 of the cutout 32 to the lower face 38 of the basic body 10, which is opposite the upper face 34, the contact springs 12, 14 extending into said contact spring cutouts.

Starting from the cylindrical holding region 30 and from the contact spring cutouts 40, 42, side sections 44, 46 illustrated in FIGS. 2 and 3 extend for the purpose of mechanically stabilizing the base 4 and improving its grip for a user. The side sections 44, 46 have cylindrical outer faces.

The contact springs 12, 14 are preferably stamped, bent sheet-metal parts with strip-shaped connecting sections 48, 50, on which contact lugs 52, 54 are provided substantially at right angles to the strip-shaped connecting sections 48, 50. If the contact springs 12, 14 are introduced into the contact spring cutouts 40, 42, the contact lugs 52, 54 are located at a predetermined distance from one another within the cutout 32 and are used for connection to contact pins of the built-in lamp 2.

The built-in lamp 2 illustrated in FIG. 3 is a halogen burner using bar-type frame technology, in which a filament with a large number of filament sections is fixed in position over a bar-type frame in the bulb 56 of the built-in lamp 2.

However, the present invention is not restricted to such incandescent lamps, but rather any desired incandescent lamp can be used, for example even halogen burners with pinch seal technology.

The bulb 56 of the built-in lamp 2 has a pinch seal 58, a section of which dips into the cutout 32 when the built-in lamp 2 is introduced into the cylindrical holding region 30. Pins 60, 62 of the built-in lamp 2 extend from the pinch seal 58 to the bottom face 36 of the cutout 32. These pins 60, 62 are preferably connected to the contact lugs 52, 54 of the contact springs 12, 14 by means of welding when the built-in lamp 2 is introduced into the basic body 10 of the base 4.

The built-in lamp 2 is connected to at least one inner wall of the cutout 30, preferably to the bottom face 36, via a cement in such a way that at least the pins, but preferably also the contact lugs of the contact springs 12, 14, are covered with the cement. Owing to the connection between the basic body 10, which preferably consists of ceramic stone, and the built-in lamp 2 via the cement, there is sufficient protection against oxidation even if no inert gas is provided within the reflector body 6.

It is therefore possible to realize a reflector lamp arrangement with a simple design and in a cost-effective manner even in the higher-wattage range up to, for example, 1000 W. The complex process of fusing the ceramic stone into the reflector body and the inert gas filling from the prior art is dispensed with.

According to experiments by the inventor, with the reflector lamp arrangement of the present invention a life of 500 hours could be achieved which is above the life of 300 hours fixed by specifications. The protection against oxidation as a result of the present invention is also successful over a period of more than 500 hours. By correspondingly dimensioning the cutout 30, a large number of different built-in burners with different pinch-seal geometries and different lamp geometries can be used for the same base 4 owing to the use of cement.

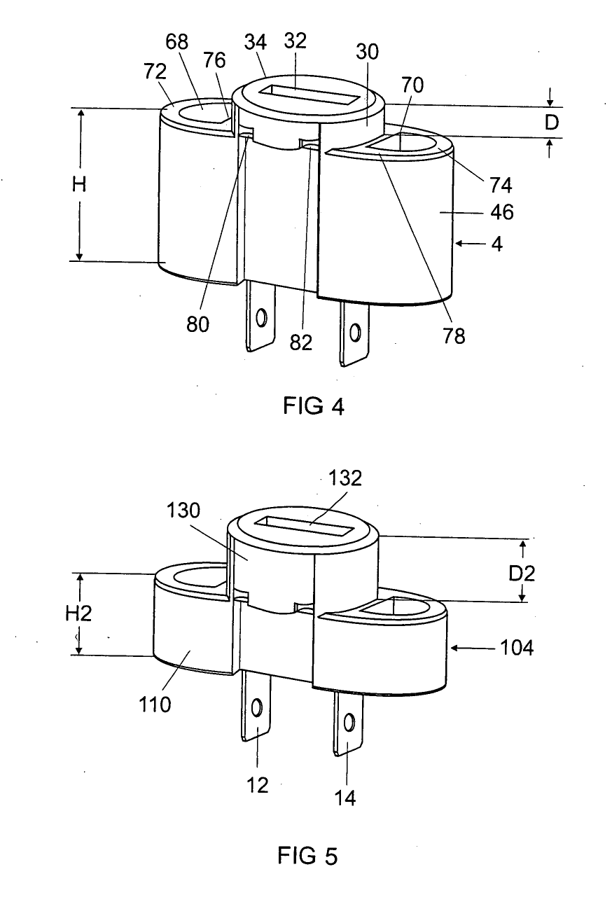

FIG. 4 shows a base 4 corresponding to a development of the first exemplary embodiment. In FIG. 3, the side sections 44, 46 are solid. The difference between the first exemplary embodiment shown in FIG. 3 and the development shown in FIG. 4 consists in the fact that cutouts 68, 70 are provided continuously in the side sections 44, 46, which cutouts each have a semicircular section 72, 74 and a flat section 76, 78. The two flat sections 72, 76 extend substantially parallel to the contact spring cutouts and point towards the cylindrical holding region 30. These cutouts 68, 70 are used for reducing the weight of the base 4.

Also, FIG. 4 shows two notches 80, 82, which are formed on the circumference of the cylindrical holding region 30 and are spaced apart from one another, and into which sections of the reflector neck 16 engage when the reflector 6 is crimped with the base 4 and bring about the interlocking connection. These notches 80, 82 are also provided in the first exemplary embodiment corresponding to FIGS. 2 and 3.

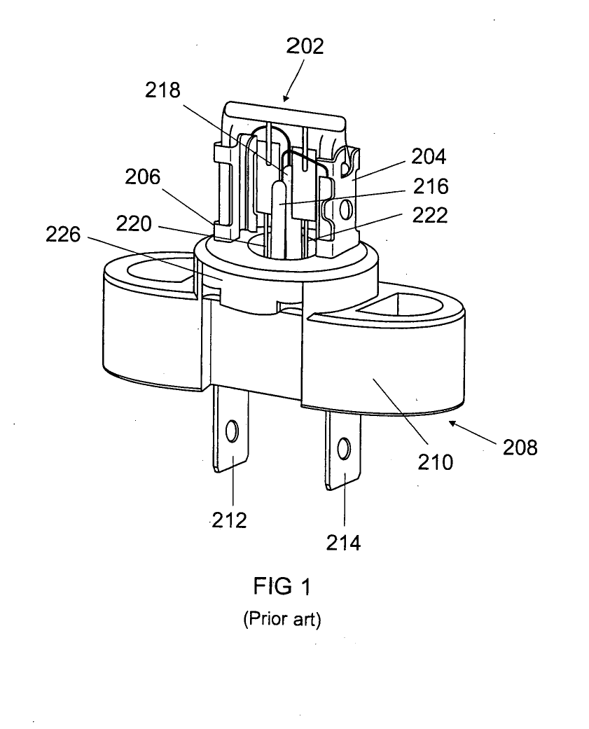

If the reflector 6 is fastened to the base 4 corresponding to the first exemplary embodiment or its development, the built-in lamp 2 dips further into the base 4 than was the case in the prior art, as is shown in FIG. 1. In order to ensure a desired emission characteristic of the reflector lamp arrangement, when designing the reflector the modified arrangement of the filament sections needs to be taken into consideration.

The reflector lamp arrangement of the first exemplary embodiment is preferably a burner unit PAR-64.

However, the present invention can also be used in other reflector lamp arrangements, for example in PAR-56, which is shown as a second exemplary embodiment in FIG. 5.

In the first exemplary embodiment, the height H of the base was greater than the height D of the cylindrical holding region on the base 4. The base 104 of the second exemplary embodiment has a height H2 of the basic body 110 and a height D2 of the cylindrical holding region 130. In this cylindrical holding region 130 there is located, in the same way as in the first exemplary embodiment, a cutout 132, into which a built-in lamp can be introduced, in which the pins of said built-in lamp can be connected to contact lugs of the contact springs 12, 14 and in which the built-in lamp can be encapsulated with the basic body 110 using cement.

Owing to the height D2 of the cylindrical holding region of the second exemplary embodiment which is enlarged in comparison with the height D of the cylindrical holding region 30 from the first exemplary embodiment, the filament sections of a built-in lamp dip further into the reflector when the reflector lamp arrangement is assembled. It is preferred that the filament sections assume the same relative position in relation to the reflector as in the case of the base 208 from the prior art.

The same built-in lamps and reflectors as are used in the prior art can therefore be used for the base according to the invention corresponding to the second exemplary embodiment. The cement, which is not illustrated in the figures, is preferably a special cement and is a curable composition, which has a low viscosity in the unhardened state. Owing to its ability to flow in the unhardened state, the cement can enter the cutout 32, 132 and surround the pins of the built-in lamp 2 in sealing fashion. Atmospheric oxygen is therefore prevented from advancing towards the pinch seal and the connection pins.

The invention therefore discloses a base for a reflector lamp arrangement having a cutout, into which a section of a built-in lamp of the reflector lamp arrangement can be inserted. The insertion can take place in such a way that the contacts of the built-in lamp can be connected to the contacts of the base in the cutout, and the built-in lamp is held via at least one wall section of the cutout. In addition, a base with a built-in lamp for a reflector lamp arrangement is provided. In this case, the base is cast with the built-in lamp by means of a composition which has low viscosity in the unhardened state, preferably by means of cement.

1. A base (4) for a reflector lamp arrangement (1), which has a cutout (32), into which a section of a built-in lamp (2) of the reflector lamp arrangement (1) can be inserted in such a way that the contacts (60, 62) of the built-in lamp are connected to the contacts (52, 54) of the base in the cutout and the built-in lamp is held via at least one wall section (36) of the cutout (32).

2. The base as claimed in claim 1, the reflector lamp arrangement being a system voltage reflector lamp arrangement, preferably a PAR lamp arrangement.

3. The base (4) as claimed in claim 1 with a built-in lamp (2) for the reflector lamp arrangement (1).

4. The base with a built-in lamp as claimed in claim 3, the built-in lamp (2) being a halogen lamp.

5. The base with a built-in lamp as claimed in claim 3, the built-in lamp (2) being capable of being fixed in the region of its pinch seal (58) via the at least one wall section (36) of the cutout.

6. The base with a built-in lamp as claimed in claim 3, the reflector lamp arrangement (1) having an electrical power of at least 300 watts and preferably at most 1000 watts.

7. The base with a built-in lamp as claimed in claim 3, the contacts (60, 62) of the built-in lamp having pins, and the contacts (52, 54) of the base (4) having contact lugs.

8. The base with a built-in lamp as claimed in claim 7, at least one contact lug (52, 54) of the base (4) being welded to a pin (60, 62) of the built-in lamp.

9. The base with a built-in lamp as claimed in claim 3, the built-in lamp (2) being cast with the base (4) by means of a composition which has low viscosity in the unhardened state, preferably by means of cement.

10. The base (4) as claimed in claim 2 with a built-in lamp (2) for the reflector lamp arrangement (1).

11. The base with a built-in lamp as claimed in claim 4, the built-in lamp (2) being capable of being fixed in the region of its pinch seal (58) via the at least one wall section (36) of the cutout.

12. The base with a built-in lamp as claimed in claim 4, the reflector lamp arrangement (1) having an electrical power of at least 300 watts and preferably at most 1000 watts.

13. The base with a built-in lamp as claimed in claim 5, the reflector lamp arrangement (1) having an electrical power of at least 300 watts and preferably at most 1000 watts.

14. The base with a built-in lamp as claimed in claim 4, the contacts (60, 62) of the built-in lamp having pins, and the contacts (52, 54) of the base (4) having contact lugs.

15. The base with a built-in lamp as claimed in claim 5, the contacts (60, 62) of the built-in lamp having pins, and the contacts (52, 54) of the base (4) having contact lugs.
